(19) United States
(12) Patent Application Publication
(10) Pub. No.: US 2025/0135971 A1
(43) Pub. Date: May 1, 2025

(54) CHILD RESTRAINT

(71) Applicant: Dorel Juvenile Group, Inc., Foxboro, MA (US)

(72) Inventors: Jason H. JOHNSON, Brownstown, IN (US); Nathan W. HEISEY, Seymour, IN (US); Grant M. MASON, Wrentham, MA (US); Sujeet Suresh THOKADE, Columbus, IN (US)

(21) Appl. No.: 18/925,793

(22) Filed: Oct. 24, 2024

Related U.S. Application Data
(60) Provisional application No. 63/545,654, filed on Oct. 25, 2023.

(51) Int. Cl. B60N 2/28

(52) U.S. Cl. CPC B60N 2/2884; B60N 2/2827

(57) ABSTRACT

A child restraint includes a seat base and a juvenile seat. The seat base is adapted to rest on a vehicle seat. The juvenile seat is coupled to the seat base. The seat base includes a seat-base foundation that supports the juvenile seat, and an energy-management pad coupled to the seat-base foundation.

### PRIORITY CLAIM

This application claims priority under 35 U.S.C. § 119 (e) to U.S. Provisional Patent Application No. 63/545,654, filed Oct. 25, 2023, which is expressly incorporated by reference herein in its entirety.

### BACKGROUND

The present disclosure relates to a child safety device, and particularly to a child car seat. More particularly, the present disclosure relates to a child car seat with features to reduce forces during an impact event.

### SUMMARY

According to the present disclosure, a child restraint includes a seat base adapted to rest on a vehicle seat and a juvenile seat coupled to the seat base to be supported on the vehicle seat by the seat base. The seat base includes a seat-base foundation having an upper surface configured to support the juvenile seat above the vehicle seat and a lower surface spaced apart from the juvenile seat and facing away from the juvenile seat and toward the seat bottom of the vehicle seat.

In illustrative embodiments, the seat base further includes an energy-management pad coupled to the lower surface of the seat-base foundation. The energy-management pad is positioned between at least a portion of the seat-base foundation and the seat bottom of the vehicle seat to absorb forces acting on the child restraint from the vehicle seat.

In illustrative embodiments, the energy-management pad includes an outer shell formed to include an interior space surrounded by the outer shell. The outer shell includes an upper wall engaged with the lower surface of the seat-base foundation, a lower wall engaged with the seat bottom of the vehicle seat, and a plurality of side walls extending between and interconnecting the upper wall and the lower wall to define the interior space between the upper wall, the lower wall, and the plurality of side walls.

In illustrative embodiments, the outer shell is blow molded to provide seamless transitions between the upper wall and the plurality of side walls and between the lower wall and the plurality of side walls. The energy-management pad is configured to change from an un-deformed state to a deformed state in response to forces acting on the energy-management pad from the seat bottom of the vehicle seat. In the undeformed state, the upper wall and the lower wall are spaced from one another in a vertical direction by a first distance. In the deformed state, the upper wall and the lower wall are spaced from one another in the vertical direction by a second distance less than the first direction.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of a child restraint, in accordance with the present disclosure, including a seat base adapted to rest on a vehicle seat and a juvenile seat coupled to the seat base, showing the seat base including an energy-management pad coupled to a lower end thereof and configured to engage the vehicle seat or other structure beneath the child restraint to reduce forces acting on the child restraint during a front-end impact event;

FIG. 2 is a side view of the seat base secured to the vehicle seat showing the energy management pad coupled to a lower end of the seat base to provide at least a portion of a bottom surface engaging the vehicle seat or other structure beneath the child restraint;

FIG. 3 is a side view of the seat base showing the energy-management pad compressed during a front-end impact event to reduce forces acting on the child restraint during the front-end impact event;

FIG. 4 is a bottom perspective view showing the energy-management pad coupled to the bottom end of the seat base to form at least a portion of a lowermost surface of the seat base;

FIG. 5 is an exploded assembly view of the seat base showing the seat base further including a seat-base foundation formed to include a pad-receiving space sized to receive the energy-management pad to removably couple the energy-management pad to the seat-base foundation;

FIG. 6 is a perspective view of the energy-management pad showing the energy-management pad including an upper wall having upper wall base and a plurality of reinforcement ribs extending downwardly away from the upper wall base toward the lowermost surface of the seat base;

FIG. 7 is a cross section of the energy-management pad taken along line 7-7 in FIG. 6 showing the energy-management pad further including a lower wall having a lower wall base spaced apart from the upper wall base to provide an interior cavity therebetween and a plurality of lower reinforcement ribs extending upwardly toward the plurality of reinforcement ribs of the upper wall;

FIG. 8 is a cross section of the seat base showing the energy-management pad coupled to the seat-base foundation and showing a tip of each of the upper and lower reinforcement ribs converging at an axis below the upper wall base and above the lower wall base to provide a pivot point for portions of the energy-management pad and/or the seat-base foundation as the energy-management pad deforms during a front-end impact event;

FIG. 9 is a top perspective view of a second embodiment of an energy management pad that can be used with the seat base, in accordance with the present disclosure, including an upper wall that is formed without reinforcement ribs;

FIG. 10 is a bottom perspective view of the second embodiment of the energy-management pad of FIG. 9 including a lower wall having a lower wall base and a plurality of lower reinforcement ribs;

FIG. 11 is a top perspective view of a third embodiment of an energy management pad that can be used with the seat base, in accordance with the present disclosure, including an upper wall that is formed without reinforcement ribs;

FIG. 12 is a bottom perspective view of the third embodiment of the energy-management pad of FIG. 11 including a lower wall having a lower wall base and a single rectangular-shaped reinforcement rib;

FIG. 13 is a top perspective view of a fourth embodiment of an energy management pad that can be used with the seat base, in accordance with the present disclosure, including an upper wall that is formed without reinforcement ribs;

FIG. 14 is a bottom perspective view of the fourth embodiment of the energy-management pad of FIG. 13 including a lower wall having a lower wall base and a single oval-shaped reinforcement rib;

FIG. 15 is a top perspective view of a fifth embodiment of an energy management pad that can be used with the seat base, in accordance with the present disclosure, including an upper wall that is formed without reinforcement ribs;

FIG. 16 is a bottom perspective view of the fifth embodiment of the energy-management pad of FIG. 15 including a lower wall that is formed without reinforcement ribs;

FIG. 17 is a top perspective view of a sixth embodiment of an energy management pad that can be used with the seat base, in accordance with the present disclosure, including an upper wall that is formed with a recess that can be used as storage space; and

FIG. 18 is a bottom perspective view of the sixth embodiment of the energy-management pad of FIG. 17 including a lower wall that is formed without reinforcement ribs.

### DETAILED DESCRIPTION

A child restraint 10 includes a seat base 12 adapted to rest on a vehicle seat 11 and a juvenile seat 14 coupled to the seat base 12 as shown in FIGS. 2 and 3. The juvenile seat 14 is supported on and attached to the vehicle seat 11 by the seat base 12. In some embodiments, the juvenile seat 14 is rotatable about a vertical rotation axis 16 to change the juvenile seat 14 from a forward facing orientation to a rearward facing orientation relative to the seat base 12.

The vehicle seat 11 includes a seat bottom 18 and a seat back 20 arranged to extend upwardly away from the seat bottom 18 as shown in FIGS. 2 and 3. In some embodiments, the seat base 12 is adapted to rest on the seat bottom 18. In some embodiments, the seat base 12 is adapted to rest on a support structure 13 as shown in FIGS. 2 and 3. In some embodiments, the support structure 13 may form part of the vehicle seat 11. In some embodiments, the support structure 13 may be separate from the vehicle seat 11, such as a structure used in testing the child restraint 10 to meet one or more safety standards (i.e. TP-213-11, at the time of filing this application) set forth by a government agency (i.e. The National Highway Traffic Safety Administration).

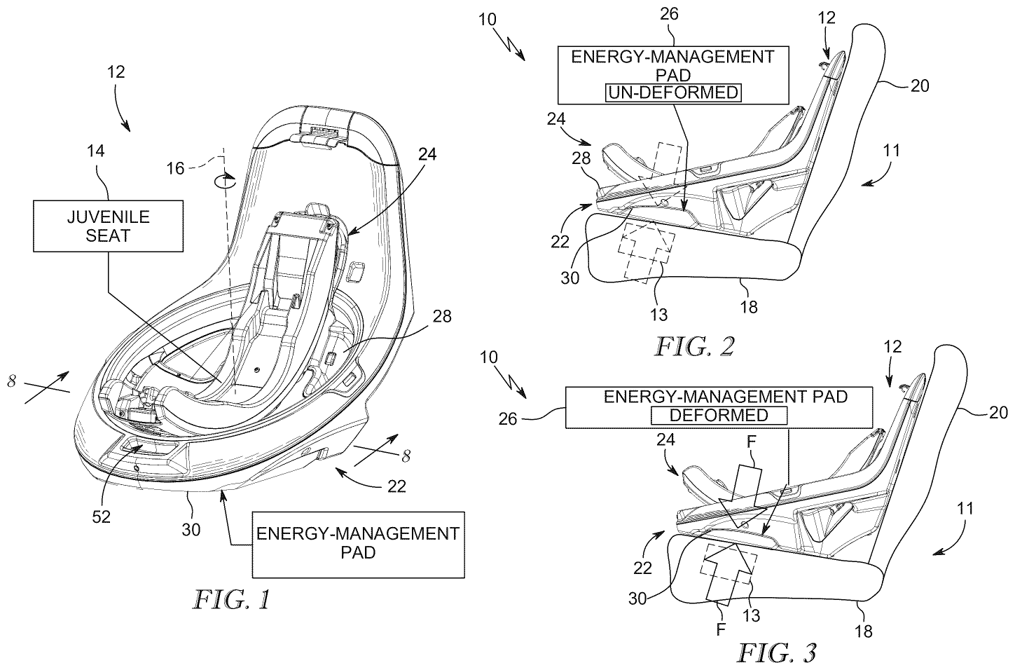

The seat base 12 includes a seat-base foundation 22, a seat-orientation controller 24, and an energy-management pad 26 as shown in FIGS. 1-3. The seat-base foundation 22 is supported on the vehicle seat 11. The seat-orientation controller 24 is coupled to the seat base 12 and mounts the juvenile seat 14 to the seat base 12 as suggested in FIG. 1. The energy-management pad 26 is coupled to the seat-base foundation 22 and is positioned between at least a portion of the seat-base foundation 22 and the seat bottom 18 of the vehicle seat 11 to absorb forces F acting on the child restraint 10 from the vehicle seat 11, for example, during a crash event. Reference is hereby made to U.S. Provisional Application No. 63/419,505 filed Oct. 26, 2022 and entitled CHILD RESTRAINT for disclosure relating to use of a seat base, which application is hereby incorporated in its entirety herein. In some embodiments, the seat-orientation controller 24 is omitted and the juvenile seat can be attached directly to the seat-base foundation 22. In yet another embodiment, the energy-management pad 26 is integrated into the seat-base foundation 22 to form a part thereof.

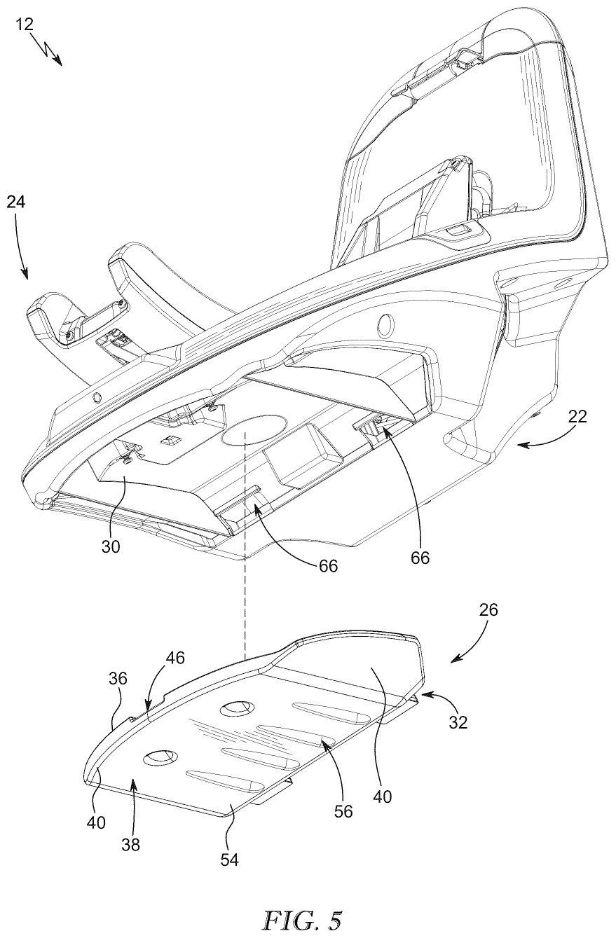

The seat-base foundation 22 includes an upper surface 28 and a lower surface 30 on an opposing side of the seat-base foundation 22 as shown in FIG. 2. The upper surface 28 faces toward the juvenile seat 14. The lower surface 30 is spaced apart from the juvenile seat 14 and faces away from the juvenile seat 14 and toward the seat bottom 18 of the vehicle seat 11 (and/or the support structure 13). The lower surface 30 of the seat-base foundation 22 is shaped to receive the energy-management pad 26 thereon as shown in FIG. 5.

The seat-orientation controller 24 is configured to secure the juvenile seat 14 to the seat-base foundation 22 and allows for selective rotation of the juvenile seat 14 relative to the seat-base foundation 22 about the vertical rotation axis 16 as suggested in FIG. 1. The seat-orientation controller 24 may also allow for selective recline of the juvenile seat 14 relative to the seat-base foundation 22, the energy-management pad 26, and portions of the seat-orientation controller 24. The seat-orientation controller 24 is coupled to the upper surface 28 of the seat-base foundation 22.

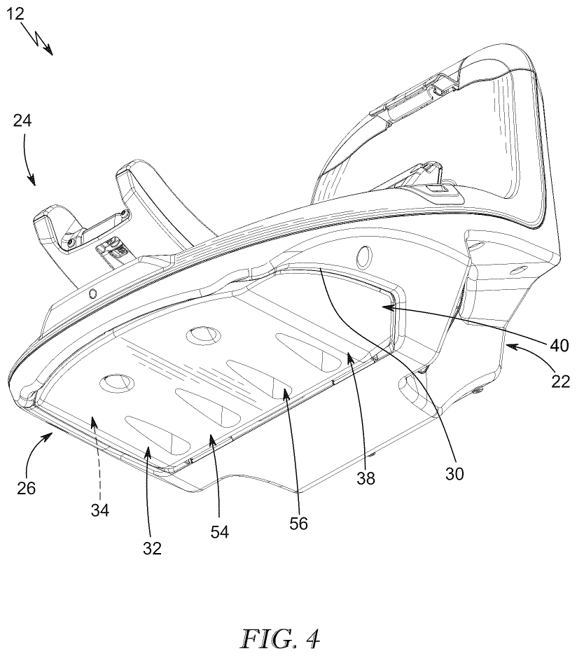

The energy-management pad 26 is coupled to the lower surface 30 of the seat-base foundation 22 to form at least a portion of a lowermost surface of the seat base 12 as shown in FIGS. 2-4. The energy-management pad 26 is configured to change from an un-deformed state, as shown in FIG. 2, to a deformed state, as shown in FIG. 3, in response to forces F acting on the energy-management pad 26 from the seat bottom 18 of the vehicle seat 11.

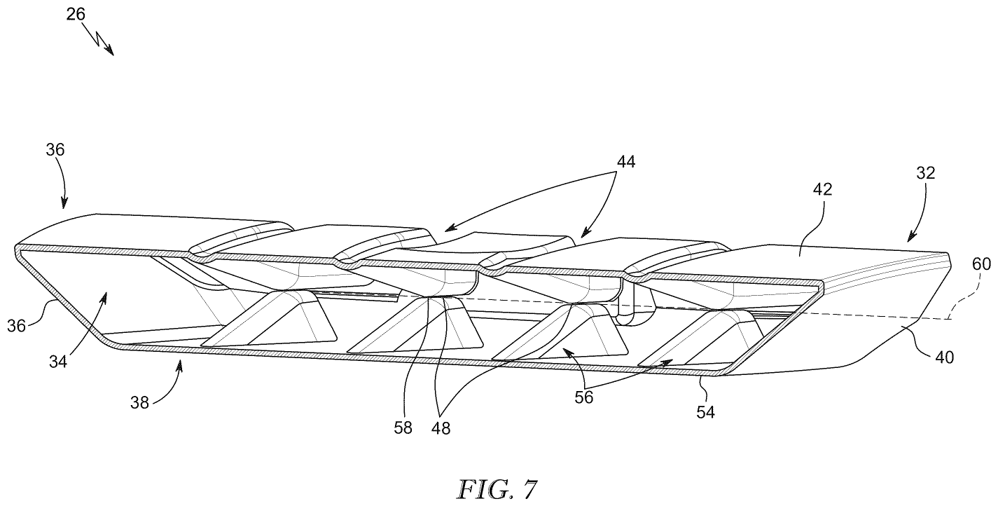

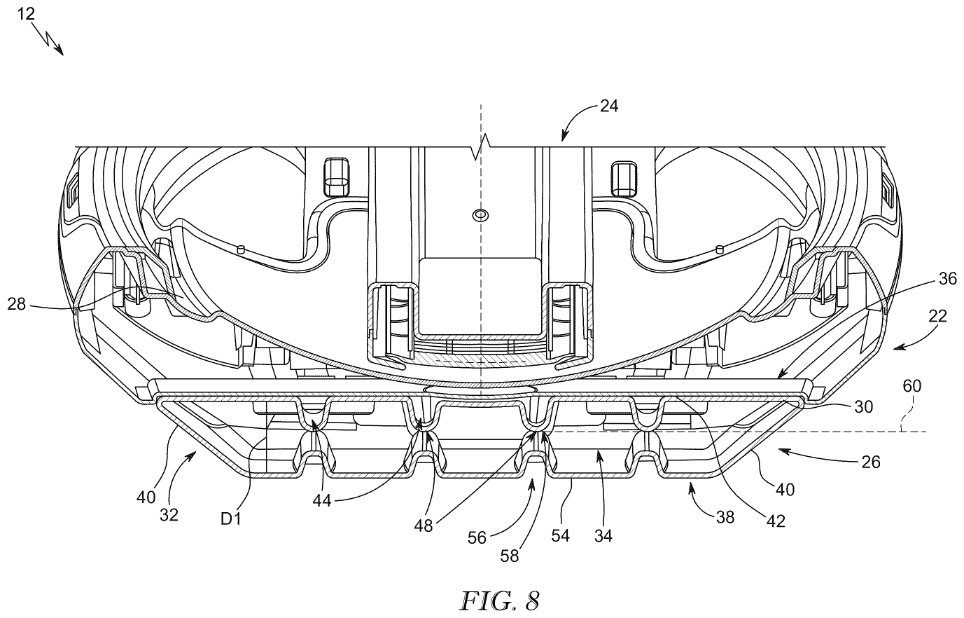

The energy-management pad 26 includes an outer shell 32 formed to include an interior space 34 surrounded by the outer shell 32 as shown in FIGS. 7 and 8. In some embodiments, the interior space 34 of the energy-management pad 26 may be hollow and filled with air. In some embodiments, the interior space 34 of the energy-management pad 26 is filled with a crushable foam or a sponge-like material.

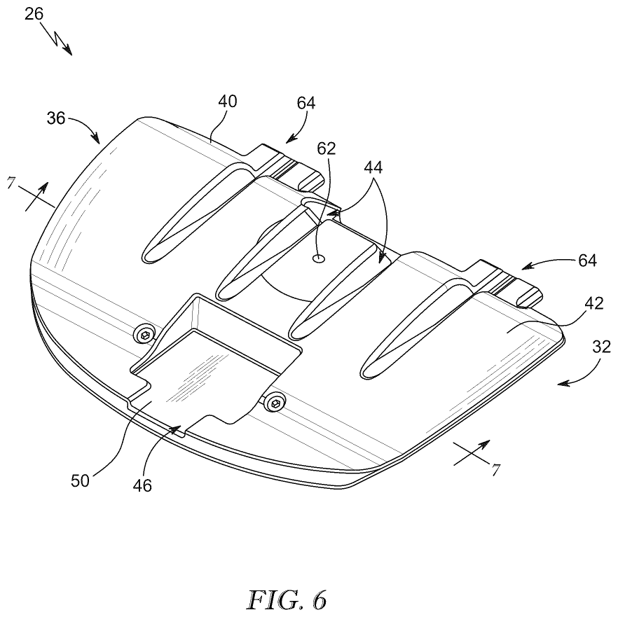

The outer shell 32 includes an upper wall 36, a lower wall 38, and a plurality of side walls 40 as shown in FIGS. 5 and 6. In the illustrative embodiment, the outer shell 32 is blow-molded to provide seamless transitions between the upper wall 36 and the plurality of side walls 40 and between the lower wall 38 and the plurality of side walls 40. The plurality of side walls 40 extend between and interconnect the upper wall 36 and the lower wall 38 to define the interior space 34 between the upper wall 36, the lower wall 38, and the plurality of side walls 40. Because the outer shell 32 is blow molded, the resulting energy management pad 26 has a generally constant thickness in each of its walls. Although the thickness is generally constant, the thickness can vary by 15-20% due to the material forming the outer shell 32 stretching more in some areas during the blow molding process.

The upper wall 36 is engaged with and/or faces toward the lower surface 30 of the seat-base foundation 22 as suggested in FIG. 5. The upper wall 36 includes an upper wall base 42, a plurality of upper reinforcement ribs 44, and a cutout 46 as shown in FIG. 6. The upper wall base 42 engages the lower surface 30 of the seat-base foundation 22. Each of the plurality of upper reinforcement ribs 44 extend downwardly away from the upper wall base 42 and toward the lower wall 38. The cutout 46 extends downwardly away from the upper wall base 42 and toward the lower wall 38.

The plurality of upper reinforcement ribs 44 may each be formed as a rib, a ridge, a protrusion, a groove, post, or any other suitable stiffening element. Illustratively, the plurality of upper reinforcement ribs 44 are triangular shaped as shown in FIGS. 6 and 7. Each of the plurality of upper reinforcement ribs 44 extend downwardly away from the upper wall base 42 to a first apex 48. A first depth of each of the plurality of upper reinforcement ribs 44 at a forward-most end of each post 44 is less than a second depth of each of the plurality of upper reinforcement ribs 44 at a rearward-most end of each rib 44 as shown in FIGS. 6 and 7. Each of the plurality of upper reinforcement ribs 44 decreases in width as the post 44 extends downwardly to the first apex 48.

The plurality of upper reinforcement ribs 44 may include any number of ribs 44, such as, but not limited to, one rib, two ribs, three ribs, four ribs, five ribs, or more. Each of the plurality of upper reinforcement ribs 44 are spaced apart from one another in a horizontal direction along the upper wall base 42 and are generally parallel with one another as shown in FIGS. 6-8. Though shown and described as triangular shaped, the plurality of upper reinforcement ribs 44 may be any suitable shape such as rectangular, trapezoidal, or another polygonal shape.

The cutout 46 is located forward of the plurality of upper reinforcement ribs 44 as shown in FIG. 6. Relative to the horizontal direction, the cutout 46 is formed at a center point of the energy-management pad 26. The cutout 46 provides a handle-receiving space 50 to provide spacing for an actuator handle 52 included in the seat base 12 therein. Illustratively, the actuator handle 52 is a release handle that, when actuated, frees the juvenile seat 14 and the seat-orientation controller 24 for rotation about the vertical rotation axis 16. The cutout 46 can be located elsewhere depending on the location of a corresponding actuator handle that is received in the cutout 46. Further, more than one cutout 46 can be included in the energy-management pad 26.

The lower wall 38 of the energy-management pad 26 is engaged with the seat bottom 18 of the vehicle seat 11 shown in FIGS. 2 and 3 and suggested in FIG. 5. The lower wall 38 includes a lower wall base 54 and a plurality of lower reinforcement ribs 56. The lower wall base 54 engages an upper surface of the seat bottom 18. Each of the plurality of lower reinforcement ribs 56 extends upwardly away from the lower wall base 54 and toward the upper wall 36.

The plurality of lower reinforcement ribs 56 may each be formed as a rib, a ridge, a protrusion, a groove, post, or any other suitable stiffening element. Illustratively, the plurality of lower reinforcement ribs 56 are triangular shaped as shown in FIGS. 7 and 8. Each of the plurality of lower reinforcement ribs 56 extend upwardly away from the lower wall base 54 to a second apex 58. A first depth of each of the plurality of lower reinforcement ribs 56 at a forward-most end of each post 56 and a rearward-most end is less than a second depth of each of the plurality of lower reinforcement ribs 56 at the second apex 58 as shown in FIGS. 6 and 7. Each of the plurality of lower reinforcement ribs 56 decreases in width as the post 56 extends upwardly to the second apex 58.

The plurality of lower reinforcement ribs 56 may include any number of ribs 56, such as, but not limited to, one rib, two ribs, three ribs, four ribs, five ribs, or more. Each of the plurality of lower reinforcement ribs 56 are spaced apart from one another in a horizontal direction parallel with the lower wall base 54 as shown in FIGS. 5 and 8. Though shown and described as triangular shaped, the plurality of lower reinforcement ribs 56 may be any shape such as rectangular, trapezoidal, or another polygonal shape.

Each of the plurality of lower reinforcement ribs 56 is aligned with a corresponding one of the plurality of upper reinforcement ribs 44 as shown in FIGS. 7 and 8. The first apex 48 of each of the plurality of upper reinforcement ribs 44 is connected to a corresponding second apex 58 of one of the plurality of lower reinforcement ribs 56. The connected apexes, 48, 58 provide a hinge 60 about which the upper wall 36 pivots as the energy-management pad 26 is changed from the un-deformed state to the deformed state. The vertical rotation axis 16 is located rearward of the hinge 60 to locate the hinge 60 between the vertical rotation axis 16 and a front end of the energy-management pad 26. In some embodiments, the apexes 48, 58 may be spaced from one another.

The energy-management pad 26 is formed to include attachment posts 64 extending from a rear end of the energy-management pad 26 as shown in FIGS. 5 and 6. Illustratively, the energy-management pad 26 includes two attachment posts 64, though, any number is contemplated. The attachment posts 64 are received in attachment slots 66 formed in the seat-base foundation 22 to couple the energy-management pad 26 to the seat base 12 as suggested in FIG. 5.

The energy-management pad 26 is formed to include at least one opening 62 that opens into the interior space 34 as shown in FIG. 6. Illustratively, the at least one opening 62 extends through the upper wall base 42 between two upper reinforcement ribs 44. In other embodiments, the at least one opening 62 is located elsewhere on the energy-management pad 26. The at least one opening 62 is sized to control release of air from the interior space 34 as the energy-management pad 26 changes from the un-deformed state to the deformed state. Additionally, the at least one opening 62 may be used during the blow-molding process to form the energy-management pad 26.

The energy-management pad 26 may change from the un-deformed state, as shown in FIG. 2, to the deformed state, as shown in FIG. 3, in response to forces F. In the un-deformed state, the upper wall 36 and the lower wall 38 of the energy-management pad 26 are spaced from one another in a vertical direction by a first distance D1 as shown in FIG. 8. In the deformed state, at least portions of the upper wall 36 and the lower wall 38 are spaced from one another in the vertical direction by a second distance that is less than the first distance D1. The forces F acting on the energy-management pad 26 from the seat bottom 18 of the vehicle seat 11 cause the upper wall 36 and the lower wall 38 to deform toward one another. As the upper wall 36 and the lower wall 38 move toward one another, air within the interior space 34 is released from the at least one opening 62.

The forces F may act on the energy-management pad 26 during a impact or deceleration event. The energy-management pad 26 absorbs and redistributes forces F acting on the child restraint 10. The absorption of the forces F increases time over which the slowing of the child restraint 10 takes place. The energy-management pad 26 disperses and dissipates the forces F, which allows a deceleration and inertial forces experienced by the child restraint 10 to decrease gradually over the course of the impact event. Further, the energy-management pad 26 may allow the child restraint 10 to meet safety standards.

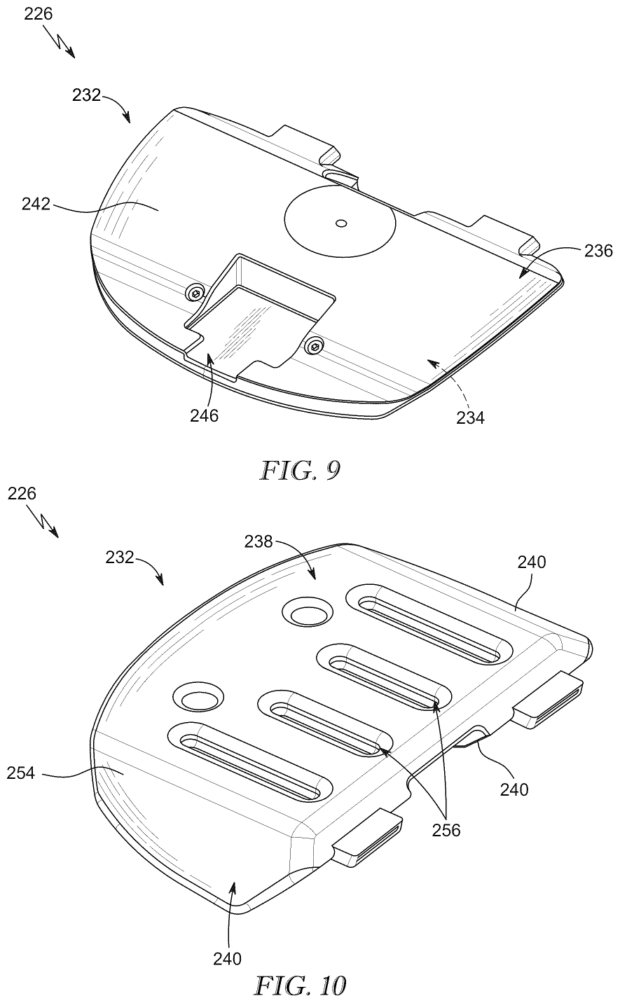

Another embodiment of an energy-management pad 226 is shown in FIGS. 9 and 10. The energy-management pad 226 includes an outer shell 232 formed to include an interior space 234 surrounded by the outer shell 232. The outer shell 232 includes an upper wall 236, a lower wall 238, and a plurality of side walls 240.

The upper wall 236 includes an upper wall base 242 and a cutout 246 as shown in FIG. 9. Illustratively, the upper wall 236 is formed without a plurality of upper reinforcement ribs.

The lower wall 238 includes a lower wall base 254 and a plurality of lower reinforcement ribs 256 as shown in FIG. 10. Each of the plurality of lower reinforcement ribs 256 extends upwardly away from the lower wall base 254 and toward the upper wall 236.

The plurality of lower reinforcement ribs 256 may each be formed as a rib, a ridge, a protrusion, a groove, or any other suitable stiffening element. A depth of each of the plurality of lower reinforcement ribs 256 at a forward-most end of each post 256 is substantially similar to a depth of each of the plurality of lower reinforcement ribs 256 at a rearward-most end of each post 256 as shown in FIG. 10.

The plurality of lower reinforcement ribs 256 may include any number of posts 256, such as, but not limited to, one post, two posts, three posts, four posts, five posts, or more. At least one of the posts 256 may have a shorter length than other posts 256 as shown in FIG. 10. Each of the plurality of lower reinforcement ribs 256 are spaced apart from one another in a horizontal direction parallel with the lower wall base 254 as shown in FIG. 10.

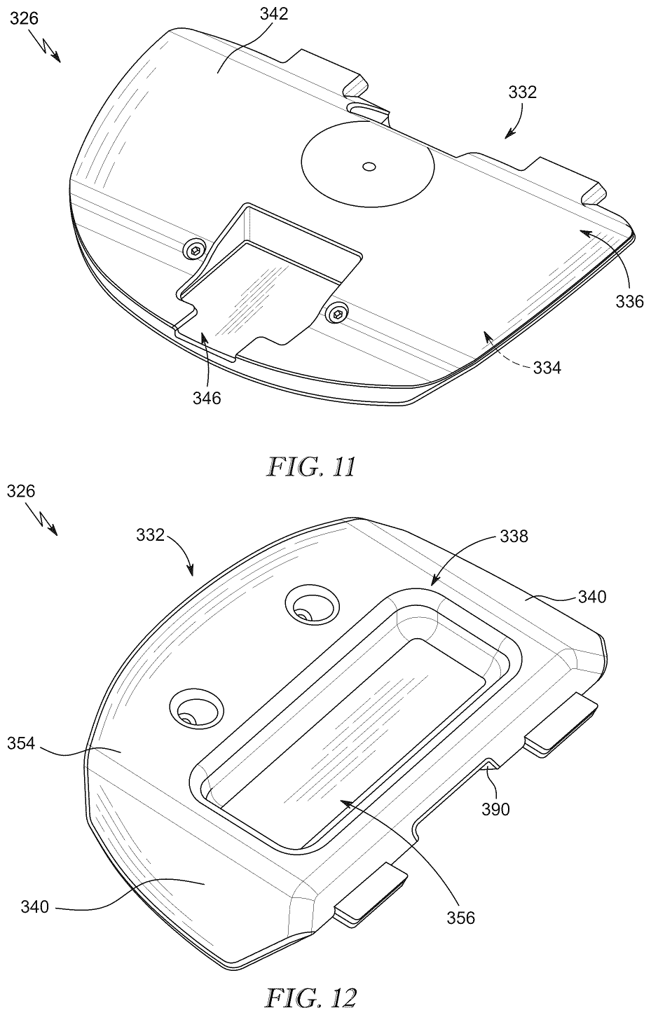

Another embodiment of an energy-management pad 326 is shown in FIGS. 11 and 12. The energy-management pad 326 includes an outer shell 332 formed to include an interior space 334 surrounded by the outer shell 332. The outer shell 332 includes an upper wall 336, a lower wall 338, and a plurality of side walls 340.

The upper wall 336 includes an upper wall base 342 and a cutout 346 as shown in FIG. 11. Illustratively, the upper wall 336 is formed without a plurality of upper reinforcement ribs.

The lower wall 338 includes a lower wall base 354 and a lower reinforcement rib 356 as shown in FIG. 12. Illustratively, the lower reinforcement rib 356 may be formed to provide a rectangular-shaped recess. The lower reinforcement rib 356 extends upwardly away from the lower wall base 354 and toward the upper wall 336.

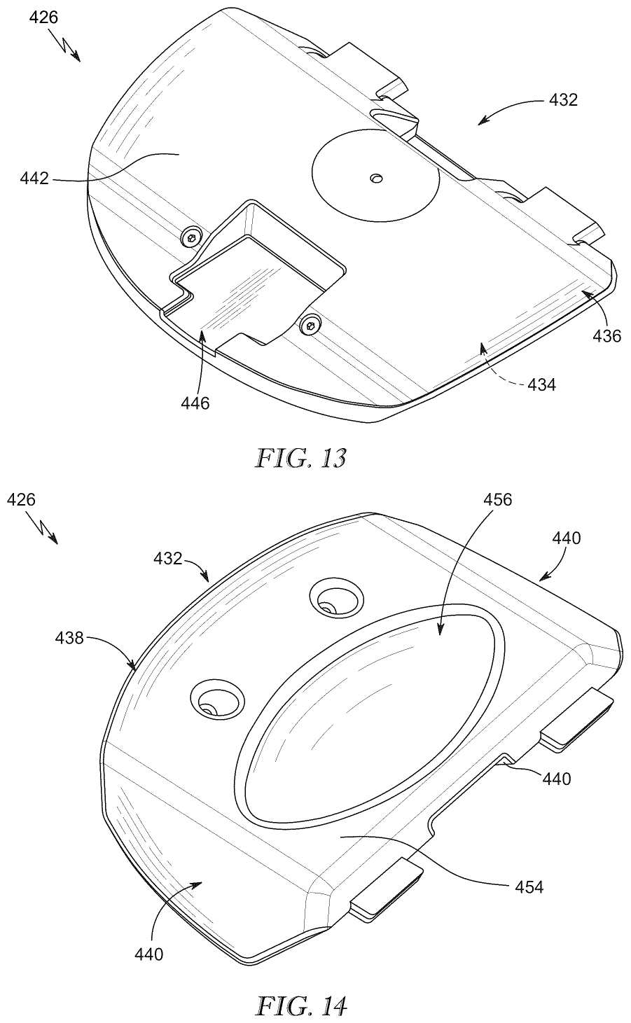

Another embodiment of an energy-management pad 426 is shown in FIGS. 13 and 14. The energy-management pad 426 includes an outer shell 432 formed to include an interior space 434 surrounded by the outer shell 432. The outer shell 432 includes an upper wall 436, a lower wall 438, and a plurality of side walls 440.

The upper wall 436 includes an upper wall base 442 and a cutout 446 as shown in FIG. 13. Illustratively, the upper wall 436 is formed without a plurality of upper reinforcement ribs.

The lower wall 438 includes a lower wall base 454 and a lower reinforcement rib 456 as shown in FIG. 14. Illustratively, the lower reinforcement rib 456 may be formed to provide an oval-shaped recess. The lower reinforcement rib 456 extends upwardly away from the lower wall base 454 and toward the upper wall 436.

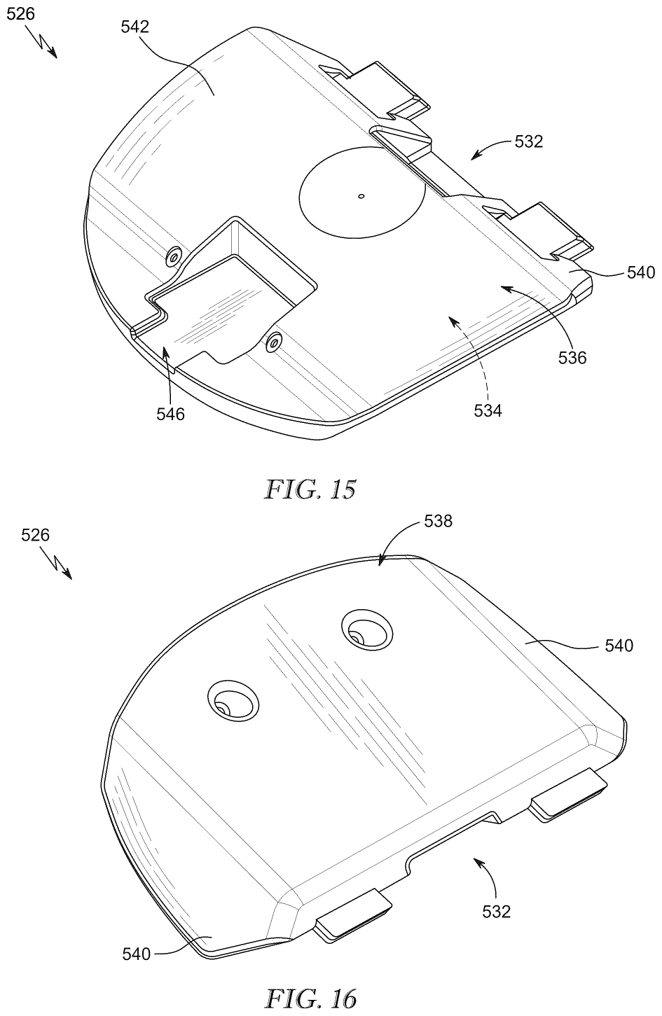

Another embodiment of an energy-management pad 526 is shown in FIGS. 15 and 16. The energy-management pad 526 includes an outer shell 532 formed to include an interior space 534 surrounded by the outer shell 532. The outer shell 532 includes an upper wall 536, a lower wall 538, and a plurality of side walls 540.

The upper wall 536 includes an upper wall base 542 and a cutout 546 as shown in FIG. 15. Illustratively, the upper wall 536 is formed without a plurality of upper reinforcement ribs, and the lower wall 538 is formed without a plurality of lower reinforcement ribs.

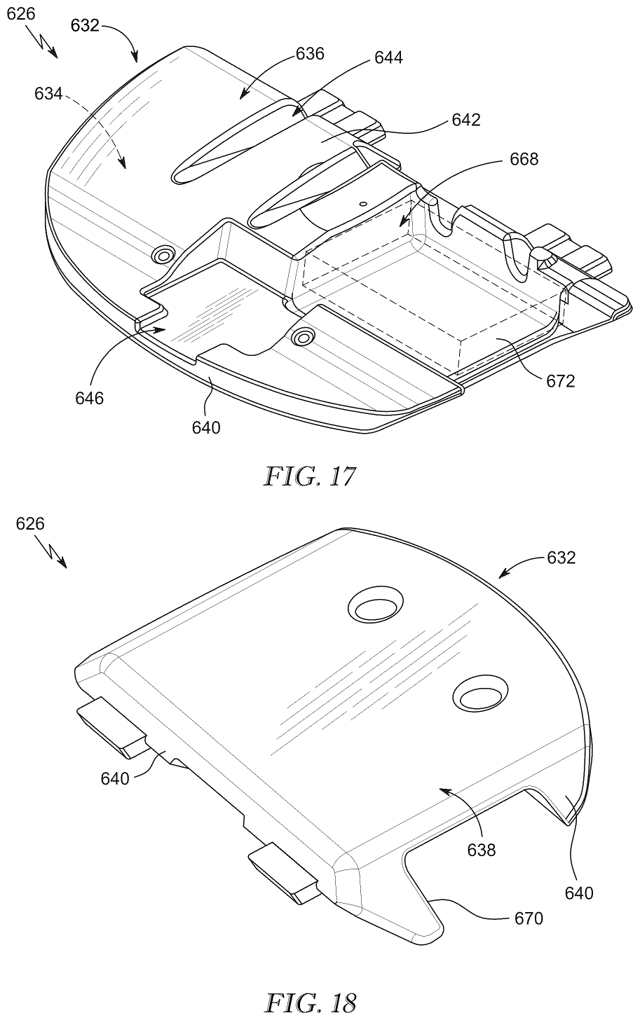

Another embodiment of an energy-management pad 626 is shown in FIGS. 17 and 18. The energy-management pad 626 includes an outer shell 632 formed to include an interior space 634 surrounded by the outer shell 632. The outer shell 632 includes an upper wall 636, a lower wall 638, and a plurality of side walls 640.

The upper wall 636 includes an upper wall base 642, a plurality of upper reinforcement ribs 644, and a cutout 646 as shown in FIG. 17. Each of the plurality of upper reinforcement ribs 644 extend downwardly away from the upper wall base 642 and toward the lower wall 638. Illustratively, the plurality of upper reinforcement ribs 644 are triangular shaped, similar to the plurality of upper reinforcement ribs 44, as shown in FIG. 17.

The upper wall 636 is formed to include a recess 668 extending downwardly from the upper wall base 642 toward the lower wall 638 as shown in FIG. 17. The recess 668 is spaced apart from the plurality of upper reinforcement ribs 644. The recess 668 cooperates with the lower surface 30 of the seat-base foundation 22 to form an accessory-storage area 672. Illustratively, the lower wall 638 is formed without a plurality of lower reinforcement ribs.

One of the plurality of side walls 640 includes a cutout 670 as shown in FIG. 18. The cutout 670 opens into the accessory-storage area 672 to allow a user to access the accessory-storage area 672. The accessory-storage area 672 is sized to receive items for storage therein, such as, but not limited to, a latch. Any of the energy-management pads 26, 226, 326, 426, 526 disclosed herein may be formed to include the accessory-storage area 672.

1. A child restraint comprising
a seat base adapted to rest on a vehicle seat having a seat bottom and a seat back arranged to extend upwardly away from the seat bottom and
a juvenile seat coupled to the seat base to be supported on the vehicle seat by the seat base,
wherein the seat base includes a seat-base foundation having an upper surface facing toward the juvenile seat and a lower surface spaced apart from the juvenile seat and facing away from the juvenile seat and toward the seat bottom of the vehicle seat, and an energy-management pad coupled to the lower surface of the seat-base foundation and positioned between at least a portion of the seat-base foundation and the seat bottom of the vehicle seat to absorb forces acting on the child restraint from the vehicle seat, and
wherein the energy-management pad includes an outer shell formed to include an interior space surrounded by the outer shell, the outer shell including an upper wall engaged with the lower surface of the seat-base foundation, a lower wall engaged with the seat bottom of the vehicle seat, and a plurality of side walls extending between and interconnecting the upper wall and the lower wall to define the interior space between the upper wall, the lower wall, and the plurality of side walls.

2. The child restraint of claim 1, wherein the outer shell is blow molded to provide seamless transitions between the upper wall and the plurality of side walls and between the lower wall and the plurality of side walls.

3. The child restraint of claim 1, wherein the energy-management pad is configured to change from an un-deformed state, in which the upper wall and the lower wall are spaced from one another in a vertical direction by a first distance, and a deformed state in response to forces acting on the energy-management pad from the seat bottom of the vehicle seat, in which the upper wall and the lower wall are spaced from one another in the vertical direction by a second distance less than the first direction.

4. The child restraint of claim 3, wherein the energy-management pad is formed to include at least one opening sized to control release of air from the interior space as the energy-management pad changes from the un-deformed state to the deformed state.

5. The child restraint of claim 3, wherein the interior space of the energy-management pad is filled with a crushable foam.

6. The child restraint of claim 1, wherein the lower wall includes a lower wall base engaged with the seat bottom of the vehicle seat and a lower reinforcement rib arranged to extend upwardly away from the lower wall base and toward the upper wall.

7. The child restraint of claim 6, wherein the upper wall includes an upper wall base engaged with the lower surface of the seat-base foundation and an upper reinforcement rib that extends downwardly away from the upper wall base and toward the lower wall.

8. The child restraint of claim 7, wherein the lower reinforcement rib and the upper reinforcement rib are aligned with one another in a vertical direction.

9. The child restraint of claim 8, wherein the lower reinforcement rib and the upper reinforcement rib each have an apex and the apex of the lower reinforcement rib and the apex of the upper reinforcement rib are connected with one another.

10. The child restraint of claim 1, wherein the lower wall includes a lower wall base engaged with the seat bottom of the vehicle seat and a plurality of lower reinforcement ribs that extend upwardly away from the lower wall base and toward the upper wall and that are spaced apart from in a horizontal direction and parallel to one another.

11. The child restraint of claim 10, wherein the upper wall includes an upper wall base engaged with the seat bottom of the vehicle seat and a plurality of upper reinforcement ribs that extend downwardly away from the upper wall base and toward the lower wall and that are spaced apart from one another in the horizontal direction and parallel to one another.

12. The child restraint of claim 11, wherein each of the lower reinforcement ribs is aligned with a corresponding upper reinforcement rib in a vertical direction.

13. The child restraint of claim 12, wherein each of the lower reinforcement ribs includes a first apex and each of the upper reinforcement ribs includes a second apex, and wherein the first apex is coupled to the second apex to provide a hinge about which at least a portion of the upper wall pivots as the energy-management pad is changed from an un-deformed state to a deformed state.

14. The child restraint of claim 13, wherein the seat base further includes a seat orientation controller configured to mount the juvenile seat to the seat base, wherein the seat orientation controller and the juvenile seat are rotatable about a vertical rotation axis relative to the seat-base foundation and the energy-management pad, and wherein the vertical rotation axis is located rearward of the hinge to locate the hinge between the vertical rotation axis and a front end of the energy-management pad.

15. The child restraint of claim 11, wherein the upper wall is formed to include a cutout to provide spacing for an actuator handle included in the seat base, the cutout being spaced apart from each of the upper reinforcement ribs.

16. A child restraint comprising
a seat base adapted to rest on a support structure and
a juvenile seat coupled to the seat base to be supported on the support structure by the seat base,
wherein the seat base includes a seat-base foundation having an upper surface facing toward the juvenile seat and a lower surface spaced apart from the juvenile seat and facing away from the juvenile seat and toward the support structure, and an energy-management pad coupled to the lower surface of the seat-base foundation and positioned between at least a portion of the seat-base foundation and the support structure to absorb forces acting on the child restraint from the support structure, and
wherein the energy-management pad includes an outer shell formed to include an interior space surrounded by the outer shell, the outer shell including an upper wall engaged with the lower surface of the seat-base foundation, a lower wall engaged with the support structure, and a plurality of side walls extending between and interconnecting the upper wall and the lower wall to define the interior space between the upper wall, the lower wall, and the plurality of side walls.

17. The child restraint of claim 16, wherein the outer shell is blow molded to provide seamless transitions between the upper wall and the plurality of side walls and between the lower wall and the plurality of side walls.

18. The child restraint of claim 16, wherein the energy-management pad is configured to change from an un-deformed state, in which the upper wall and the lower wall are spaced from one another in a vertical direction by a first distance, and a deformed state in response to forces acting on the energy-management pad from the support structure, in which the upper wall and the lower wall are spaced from one another in the vertical direction by a second distance less than the first distance.

19. The child restraint of claim 16, wherein the lower wall includes a lower wall base engaged with the support structure and a lower reinforcement rib that extends upwardly away from the lower wall base and toward the upper wall,
wherein the upper wall includes an upper wall base engaged with the lower surface of the seat-base foundation and an upper reinforcement rib that extends downwardly away from the upper wall base and toward the lower wall,
wherein the lower reinforcement rib and the upper reinforcement rib are aligned with one another in a vertical direction, and
wherein the lower reinforcement rib and the upper reinforcement rib each have an apex and the apex of the lower reinforcement rib and the apex of the upper reinforcement rib are connected with one another to provide a hinge point.

20. A child restraint comprising
a seat base adapted to rest on an underlying support structure and
a juvenile seat coupled to the seat base to be supported on the support structure by the seat base,
wherein the seat base includes an energy-management pad having an upper wall and a lower wall engaged with the support structure,
wherein the lower wall includes a lower wall base engaged with the support structure and a plurality of lower reinforcement ribs that extend upwardly away from the lower wall base and toward the upper wall and that are spaced apart from one another in a horizontal direction parallel with the lower wall base,
wherein the upper wall includes an upper wall base engaged with the support structure and a plurality of upper reinforcement ribs that extend downwardly away from the upper wall base and toward the lower wall and that are spaced apart from one another in the horizontal direction parallel with the upper wall base,
wherein each of the lower reinforcement ribs is aligned with a corresponding upper reinforcement rib in a vertical direction, and
wherein each of the lower reinforcement ribs includes an first apex and each of the upper reinforcement ribs includes a second apex, and wherein the first apex is coupled to the second apex to provide a hinge about which the upper wall pivots as the energy-management pad changes from an un-deformed state to a deformed state.
